(19) United States
(12) Patent Application Publication
(10) Pub. No.: US 2005/0220938 A1
(43) Pub. Date: Oct. 6, 2005

(54) Method for manufacturing proteoses derived from animal protein and manufacturing food containing the proteoses

(76) Inventors: Kazuyo Abe, Odawara (JP); Kenei Man, Odawara (JP)

Correspondence Address: BROMBERG & SUNSTEIN LLP, 125 SUMMER STREET, BOSTON, MA, 02110-1618, US

(21) Appl. No.: 10/784,483

(22) Filed: Feb. 20, 2004

(30) Foreign Application Priority Data
Dec. 16, 2003 (JP) 2003-418203

(51) Int. Cl. A23L 1/31

(52) U.S. Cl. 426/56

(57) ABSTRACT

The present invention is intended to provide a cheap and safe method for manufacturing proteoses derived from animal protein by directly using plants containing endopeptidases. Further, the present invention is intended to provide food and drink that include the proteoses. The inventors found that proteoses derived from animal protein could be made by directly mixing animal protein with plants containing endopeptidases under a specific condition, because the endopeptidases hydrolyze the animal protein and produce the proteoses. Consequently, the present invention was conceived.

### TECHNICAL FIELD

This invention provides a method for manufacturing proteoses derived from animal protein by using plants that have endopeptidases. Furthermore, this invention provides food that includes the proteoses.

### BACKGROUND OF INVENTION

In addition to water, five major nutrients, protein, lipids, carbohydrates, vitamins, and minerals, are essential to maintain human life. Animal protein such as meat from livestock, poultry, fish, shellfish, and eggs is an important source of protein for humans. Generally, the protein used as food is raw, cooked, or processed animal protein. For example, some processed animal protein contains sausage and steamed fish paste, which have no muscle fiber. In the process for manufacturing the steamed fish paste, ground meat paste is made from fish meat, because the fish meat dissolves into myosin and actin, which are major components of the muscle protein when a bit of salt is added to the fish meat and the fish meat is ground. Since anastomoses are made from molecules of the protein when the meat paste is heated, the boiled fish paste is completed by forming the meat paste into particular shapes and by heating the shaped pieces. Similarly, a tube-shaped fish paste cake and fried fish paste can be made from the fish meat. These are products using not the meat of the animal, but the molecules of the protein in the muscle.

Recently, since an aging society has advanced rapidly and the diets of people have been diversified, protein food that is easy to eat or digest has been required. For example, required are protein food easy to swallow, such as baby food, and food for the aged, supplementary food of protein for youths, and protein food and drinks for supplying athletes with energy.

Various types of food and cosmetics having processed animal protein are well known. To respond to the above requirements, these foods and cosmetics are made by adding proteoses that are made by plant-originating or microorganism-originating endopeptidases.

For example, a method for hydrolyzing enzymes of milk whey protein has been disclosed. (See reference No. 1.) β-lactoglobulins in an aqueous solution of milk whey protein that has a concentration of 5 to 20 wt. % are selectively hydrolyzed by using plant-originating endopeptidases, such as bromelain and papain.

A method for hydrolyzing protein by using plant-originating endopeptidases that are refined and commercially available has been disclosed. (See reference No. 2.) These plant-originating endopeptidases are incubated with the protein, and then the protein is hydrolyzed.

Disclosed has been a method to obtain a peptide mixture capable of inhibiting angiotensin-converting enzymes and having high inhibition activity, and to provide food containing the peptide mixture. (See reference No. 3.) The protein of animals, vegetables, fish, and shellfish react with commercially available enzymes or enzymes existing in tissue to form the proteoses. The proteoses are filtered during the reaction. Free amino acids and other low-molecular components unrelated to the inhibition of angiotensin-converting enzymes are removed by filtration with a reverse osmosis membrane to obtain a peptide mixture.

The above references are as follows:
(1) Reference No. 1: Japanese Patent Publication Laid-open No. 5-103595
(2) Reference No. 2: Japanese Patent Publication Laid-open No. 8-509366
(3) Reference No. 3: Japanese Patent Publication Laid-open No. 6-7188

### SUMMARY OF INVENTION

In the conventional art explained above, since the protein is hydrolyzed by using plant-originating or microorganism-originating endopeptidases, expensive equipment for deriving endopeptidases from the plants or microorganisms and for refining the endopeptidases is required. The commercially available endopeptidases are also expensive. Furthermore, the processes to obtain the endopeptidases must be simple, and safe for human health.

The present invention is intended to overcome these disadvantages and to provide a method for manufacturing proteoses derived from animal protein by directly using plants containing endopeptidases. Furthermore, the present invention is intended to provide food that includes those proteoses.

The inventors found that under a specific condition proteoses derived from animal protein could be made by directly mixing animal protein with plants containing the endopeptidases, because the endopeptidases hydrolyze the animal protein and produce the proteoses. Consequently, the present invention was conceived.

A method for manufacturing proteoses derived from animal protein according to the present invention is comprised of:
(1) a cutting step to finely cut animal protein and plants containing endopeptidases,
(2) a mixing step to mix the animal protein with the plants,
(3) a hydrolyzing step to hydrolyze the animal protein by the endopeptidases, and
(4) an ending step to stop the activity of the endopeptidases.

Plants containing the endopeptidases include papayas, maitake mushrooms, figs, kiwi fruits, pineapples, melons, and fresh ginger. Any of these plants alone or two or more together may be used to hydrolyze the animal protein.

In accordance with the hydrolyzing step to hydrolyze the animal protein, the mixture of the animal protein and the plants containing the endopeptidases may be maintained at the range of a pH (hydrogen exponent) between 2.0 and 11.0, and for at least one minute at a temperature between 0 and 75° C.

In accordance with the mixing step, the wt. % of the animal protein may be 0.1 to 99.9, and the wt. % of the plants containing the endopeptidases may be 0.1 to 99.9.

Alternatively, in accordance with the mixing step, the wt. % of the animal protein may be 80 to 99.5, and the wt. % of the plants containing the endopeptidases may be 0.5 to 20.

The present invention provides various kinds of proteoses made by the above method.

Furthermore, the present invention provides various kinds of food containing the proteoses made by the above method.

In accordance with the present invention, since the animal protein is hydrolyzed by directly using plants containing endopeptidases, various kinds of proteoses can be manufactured cheaply and safely. Also, various kinds of food and drink containing the proteoses can be provided cheaply and safely.

### BRIEF DESCRIPTION OF THE DRAWINGS

FIG. 1 is a photograph of the results of electrophoresis to evaluate the effect of hydrolyzing fish meat protein by using plants containing endopeptidases.

FIG. 2 is a photograph of the results of electrophoresis to evaluate the effect of pH values in the process for hydrolyzing fish meat protein by using maitake mushrooms.

FIG. 3 is a photograph of the results of electrophoresis to evaluate the effect of pH values in the process for hydrolyzing fish meat protein by using papaya peels.

### PREFERRED EMBODIMENT OF THIS INVENTION

In accordance with the present invention, the animal protein includes fish meat, meat of aquatic animals, except for fishes, poultry such as chickens, meat of livestock such as pork and beef, and eggs. In preferred embodiments of this invention, meat paste, ground meat, myofibrils, and processed meat can be used as the animal protein. Animal protein that has been denatured by heating or the mixture of these meats can be also used as the animal protein.

Plants containing endopeptidases include papayas, maitake mushrooms, figs, kiwi fruits, pineapples, melons, fresh ginger, and star-shaped fruits, but are not restricted to these plants. These plants contain the endopeptidases, for example, papain and chymopapain, of papayas, metalloendopeptidase of maitake mushrooms, ficin of figs, actinidin of kiwi fruits, bromelain of pineapples, cucumisin of melons, ginger protease II, or zingibain of fresh ginger. These endopeptidases hydrolyze the protein.

There is a difference in the activity of the endopeptidases, depending on the parts of the plants. However, all parts of the plants can be used for the purpose of this invention. For example, while the activity of the endopeptidase of papaya peels is higher than that of papaya pulp, both parts of a papaya can be used. Especially, the activity of the endopeptidase of a green papaya is higher than that of a ripened papaya. Further, the activity of the endopeptidase of the maitake mushroom stalk is the same as that of the cap. Thus, both parts of the maitake mushroom can be used. Namely, it is important that the stalk of the maitake mushroom and the peel of the papaya, both of which are of no utility, can be used for the purpose of this invention.

One or more of these plants may be used for the purpose of this invention.

The cutting step to finely cut the animal protein and the plants and the mixing step to mix the animal protein with the plants are important for hydrolyzing the protein efficiently. According to the preferred embodiments of this invention, the animal protein and the plants containing endopeptidases are finely cut and mixed by a food cutter. Alternatively, other cutting and mixing apparatuses can replace the food cutter.

About the mixing ratio of the animal protein and the plants containing the endopeptidases, the wt. % of the plants may be 0.1 to 99.9, and that of the animal protein may be 0.1 to 99.9. Preferably, the wt. % of the plants may be 0.1 to 50.0, and that of the animal protein may be 50.0 to 99.9. Further preferably, the wt. % of the plants may be 0.5 to 20.0, and that of the animal protein may be 80.0 to 99.5. If the wt. % of the plants is less than 0.1, the rate of hydrolyzing the animal protein becomes too slow, and if it is more than 99.9, a sufficient amount of the proteoses cannot be produced. Thus, the range of these weight percentages of the plants is inappropriate for the commercial production of the proteoses.

Salt, sugar, and other seasonings may be added to the animal protein and the plants containing the endopeptidases. If salt is added up to 3 wt. %, the animal protein can be hydrolyzed by the endopeptidases in the plants.

The animal protein may be hydrolyzed by the endopeptidases at below 0° C. Generally, as the temperature increases, the activity of the endopeptidases proportionately rises. The maximum activity of the endopeptidases is achieved at a temperature between 60 and 70° C. However, the activity of the endopeptidases stops at a temperature of 85° C.

The animal protein can be hydrolyzed by endopeptidases at a pH value between 2.0 and 11.0. The optimal pH of the endopeptidases is a natural range.

The hydrolysis of the protein begins as soon as the animal protein and the plants containing the endopeptidases are finely cut and mixed with each other. The hydrolysis of the protein may be substantially completed within ten minutes.

Thus, a temperature between 0 and 75° C. is preferable for hydrolyzing animal protein, and a temperature between 50 and 70° C. is further preferable. A duration of more than one minute is preferable for hydrolyzing animal protein, and a duration between 10 minutes and 24 hours is further preferable. If the temperature is below 0° C., the rate of hydrolyzing the animal protein becomes too slow, and if it is above 75° C., the activity of the endopeptidases decreases, and stops at 85° C. Thus, a temperature range that goes below 0° C. or goes above 75° C. is inappropriate for the commercial production of proteoses. Since the range of the pH values to maintain the activity of the endopeptidases is broad, it is unnecessary to control the pH value of the mixture of the animal protein and the plants.

The animal protein may be hydrolyzed by the endopeptidases in the plants after the mixture of the animal protein and the plants containing the endopeptidase is packed in a vacuum.

Preferably, the mixture of the animal protein and the plants is maintained at a temperature between 75 and 95° C. for a period between 5 minutes and 2 hours to stop the activity of the endopeptidases after the hydrolysis of the animal protein is completed. Further preferably, the mixture should be maintained at a temperature between 80 and 90° C. for a period between 15 minutes and 1 hour. If the temperature is below 75° C., the activity of the endopeptidases cannot be stopped. In the commercial production of the proteoses, a temperature between 100 and 121° C. may be applied to sterilize a boil-in-the-bag food and at the same time to stop the activity of the endopeptidases.

The proteoses of the animal protein produced by the above method in accordance with the present invention may be strained, packed, and stored at suitable conditions, if necessary.

The protein concentration of the proteoses that are made by the above method and that of the animal muscle are the same. Since the animal proteins are hydrolyzed by the endopeptidases, no anastomoses are formed, when the proteoses are heated. Thus, since the proteoses exist in a paste-like or liquid-like form, the proteoses can be used for various kinds of food. For example, there are juices, noodles, jams, jellies, dressings, breads, and yogurts containing the proteoses. However, the foods containing the proteoses are not restricted to these foods. The proteoses content of these foods may be varied widely according to the type and purpose of the food.

Tables 1 to 6 show the preferred embodiments of this invention. Especially, Tables 1 and 2 show the preferred embodiments with comparable examples. In all of these preferred embodiments and the comparable examples, the animal protein and the plants containing the endopeptidases are added to each other at the specific weight ratios that are listed in the tables, and are finely cut by the food cutter and sufficiently mixed. Chemicals A, B, and C for controlling the pH values shown in the tables are as follows:
Chemicals A: 0.6 M(mol) KCl, 20 mM Tris-HCl buffer
Chemicals B: citric acid-Na₂HPO₄ buffer
Chemicals C: Na₂CO₃—NaHCO₃ buffer

In all of these preferred embodiments and the comparable examples shown in Tables 1 to 6, the animal protein is heated at a temperature of 85° C. for 30 minutes to stop the activity of the endopeptidases after the hydrolysis of the protein is completed.

The state of decomposition of the MHCs (myosin heavy chains) listed in the columns of Tables 1 to 6 is based on the results of the electrophoresis. The electrophoresis described in this specification is sodium dodecyl sulfate-polyacrylamide gel electrophoresis (SDS-PAGE). It uses a polyacrylamide gel of a concentration between 10% and 20% and contains an SDS having a concentration of 0.1%, and is based on the method of Laemmli and Farve (U. K. Laemmli and M. Farve; J. Mol. Biol. 80, 579-599 (1973)). Each fragment is dyed by Coomassie Brilliant Blue R-250 to observe them.

Also used is a method for judging the state of decomposition of a protein based on checking whether the hydrolyzed protein becomes gel-like. This method uses the difference between the characteristics of the protein and the proteoses. Namely, the protein forms a gel when it is dissolved by salt, and heated, while the proteoses hydrolyzed by the endopeptidases do not form a gel.

The method for measuring the protein concentration of the proteoses shown in Tables 1 to 6 is based on the method of A. G. Gornall, et al. (A. G. Gornall, C. J. Bardawill, and M. M. David; J. Biol. Chem., 177, 751-766(1949)). The biuret method is employed to measure the protein concentration. In this method, bovine serum albumin is employed as a standard, a spectrophotometer is employed, and colorimetric analysis is performed at a wavelength of 560 nm.

### Embodiments

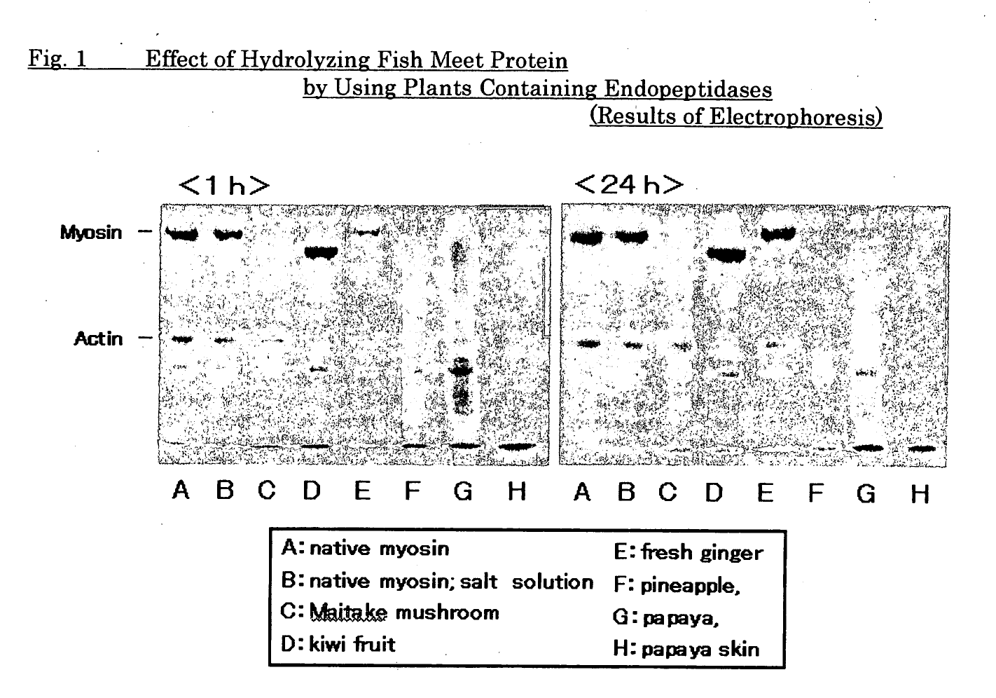

Embodiment Nos. 1-1 to 5-4 of Tables 1 and 2 show the results of experiments to evaluate the methods for manufacturing the proteoses. A fish meat protein is employed as the animal protein, and maitake mushrooms, kiwi fruit pulps, pineapple pulps, papaya pulps, and papaya peels are employed as the plants containing the endopeptidases that are enzymes for hydrolyzing the protein. One of these plants is added to the fish meat at a ratio of 50:50 wt. %. Then the fish meat protein is hydrolyzed. The proteoses produced under the conditions shown in Tables 1 and 2 are evaluated by the electrophoresis (SDS-PAGE). The MHCs (myosin heavy chains) are completely decomposed in one hour, and the bands of the myosin disappear. Namely, it was found that the fish meat protein was completely hydrolyzed. FIG. 1 is a photograph of the results of the electrophoresis to evaluate the effect of the method for hydrolyzing the fish meat protein by using the plants containing endopeptidases. The fish meat protein is hydrolyzed for from 1 to 24 hours.

According to comparable examples Nos. 1 to 5, which do not include any plants such as the maitake mushrooms, kiwi fruits, pineapples, or papayas, while the conditions of the process for hydrolyzing the protein are the same as embodiment Nos. 1-1 to 5-4, the MHCs are not decomposed. Thus, it was found that the hydrolysis of the protein occurs not by means of the proteases originally existing in the fish meat, but by the endopeptidases existing in the above plants.

Embodiment Nos. 6 to 9 of Table 3 also show the results of experiments to evaluate the method for manufacturing the proteoses. A frozen fish meat paste is employed as the animal protein, and maitake mushrooms, papaya peels, or green papaya peels are employed as the plants containing the endopeptidases. Frozen ground fish meat at 97 wt. % and one of the above plants at 3 wt. % are added to each other, and then the ground fish meat is hydrolyzed. The proteoses produced under the conditions of Table 3 are evaluated by a method for judging the state of decomposition of the protein based on checking whether the hydrolyzed protein has become gel-like. Since the proteoses do not form a gel, it was found that the protein of the frozen ground fish meat is sufficiently hydrolyzed. The protein concentration of the proteoses was measured, and was found to be the same as that of the frozen fish meat paste.

Embodiment Nos. 10 and 11 of Table 3 also show the results of experiments to evaluate the method for manufacturing the proteoses. A frozen fish meat paste is employed as the animal protein, and maitake mushrooms or papaya peels are employed as the plants containing the endopeptidases. One of the above plants at 3 wt. % and salt at 3 wt. % are added to the frozen fish meat paste at 94 wt. %, and then the fish meat paste is hydrolyzed. Generally, the activity of the endopeptidases is affected by the salt. In these embodiments, however, while it is recognized that the activity of the endopeptidases is slightly reduced, it was found that the protein of the frozen fish meat paste was sufficiently hydrolyzed, since the proteoses do not form a gel. Thus, if salt is added, the activity of the endopeptidases is maintained. However, it is preferable that the protein be hydrolyzed by the endopeptidases without salt.

Embodiment Nos. 12, 13, and 14 of Table 4 also show the results of the experiments to evaluate the method for manufacturing the proteoses. A frozen fish meat paste preheated to denature the protein is employed as the animal protein, and maitake mushrooms or papaya peels are employed as the plants containing the endopeptidases. In these embodiments, the protein of the frozen fish meat paste is sufficiently hydrolyzed, and the proteoses do not form a gel.

Embodiment Nos. 15, 16, and 17 of Table 4 also show the results of the experiments to evaluate the method for manufacturing the proteoses. Ground meat from the leg of a chicken is employed as the animal protein, and maitake mushrooms or papaya peels are employed as the plants containing the endopeptidases. In these embodiments, the protein of the ground meat of the leg of the chicken is sufficiently hydrolyzed, and the proteoses do not form a gel. The protein concentration of the proteoses is measured, and is the same as that of the ground meat of the leg of the chicken.

Embodiment Nos. 18, 19, and 20 of Table 4 also show the results of the experiments to evaluate the method for manufacturing the proteoses. Ground pork is employed as the animal protein, and maitake mushrooms or papaya peels are employed as the plants containing the endopeptidases. In these embodiments, the protein of the ground pork is sufficiently hydrolyzed, and the proteoses do not form a gel. The protein concentration of the proteoses is measured, and is the same as that of ground pork.

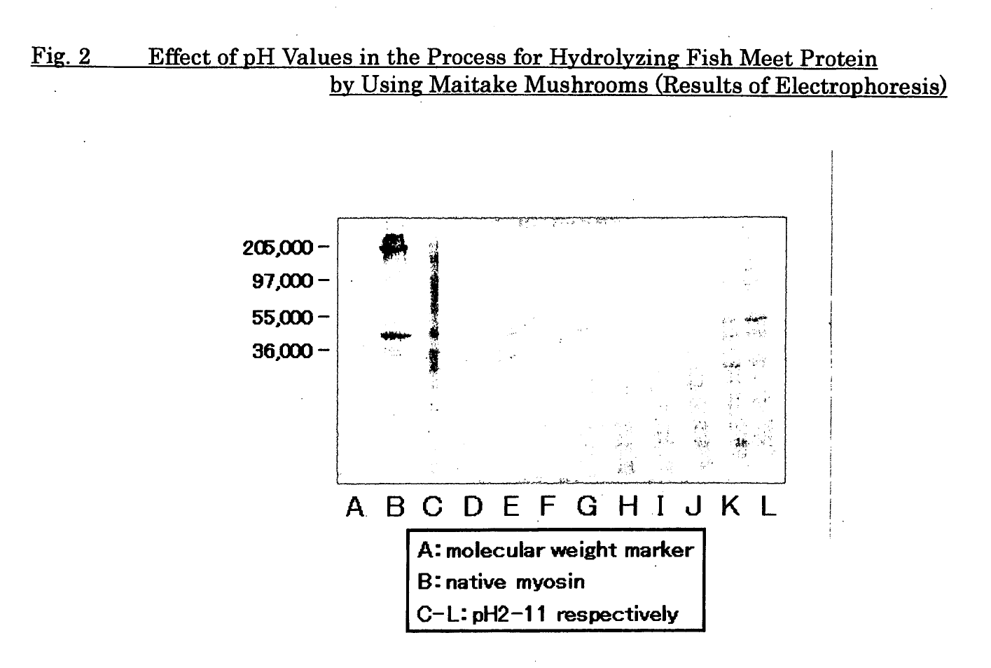

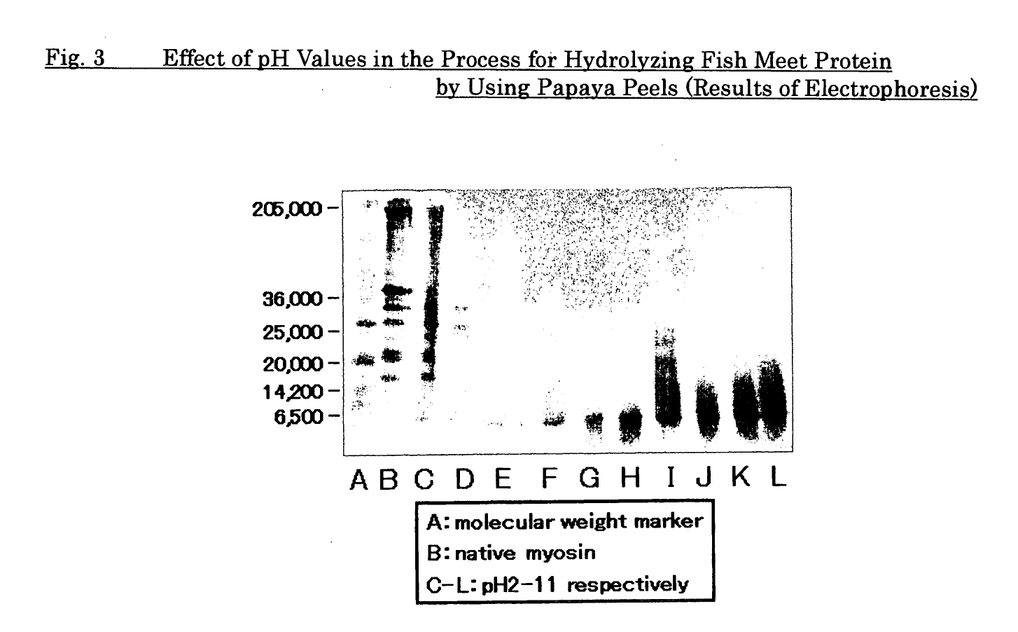

Embodiment Nos. 21 and 22 of Table 5 show the results of the experiments to evaluate the effect of the pH value on the mixture in the process for manufacturing the proteoses. Fish meat is employed as the animal protein, and maitake mushrooms or papaya peels are employed as the plants containing the endopeptidases. The pH value of the mixture of the animal protein and the plants is controlled to be between 2 and 11. In all of these embodiments, the MHCs are decomposed, and the bands of the myosin disappear. For example, when the protein of the fish meat is hydrolyzed by the endopeptidases existing in maitake mushrooms, it is found that the activity of the endopeptidases is higher when in the range of a pH value between 4 and 9. FIG. 2 is a photograph of the results of the electrophoresis to evaluate the effect of the pH values of the mixture in the process for hydrolyzing the fish meat protein by using maitake mushrooms. Similarly, FIG. 3 is a photograph of the results of the electrophoresis to evaluate the effect of the pH values of the mixture in the process for hydrolyzing the fish meat protein by using papaya peels.

Embodiment Nos. 23 and 24 of Table 5, and No. 25 of Table 6, show the results of experiments to evaluate the effect of the temperature in the process for manufacturing the proteoses. A frozen fish meat paste is employed as the animal protein, and maitake mushrooms or papaya peels are employed as the plants containing the endopeptidases. The temperature of the mixture of the animal protein and the plants is controlled to be between 0 to 80° C. to hydrolyze the frozen fish meat paste. In all of these embodiments, the protein of the frozen fish meat paste is sufficiently hydrolyzed, and the proteoses do not form a gel. The activity of the endopeptidases depends on the temperature of the mixture. For example, the endopeptidase of papaya peels further activates at a temperature of 70° C., and the endopeptidase of maitake mushrooms further activates at a temperature of 60° C.

Embodiment Nos. 26 and 27 of Table 6 show the results of experiments to evaluate the effect of the ratio of the plants to the mixture in the process for manufacturing the proteoses. A frozen fish meat paste is employed as the animal protein, and maitake mushrooms or papaya peels are employed as the plants containing the endopeptidases. In each of these embodiments, the protein of the frozen fish meat paste is sufficiently hydrolyzed, and the proteoses do not form a gel. As a result of this embodiment, a ratio of 3 wt. % of the plants containing the endopeptidases is sufficient to hydrolyze the animal protein.

Embodiment Nos. A1 to A11 of Table 7 show foods that contain the proteoses of the animal protein hydrolyzed by the plants containing the endopeptidases.

Embodiment Nos. A1, A2, and A3 are spread-type foods containing the proteoses. These foods are made by seasoning the paste-like or liquid-like proteoses derived from the animal protein with salt or sugar, and by adding ground sesame seeds, chocolate, or soybean flour. The proteoses may be seasoned with curry powder or pepper. The spread-type foods further contain a peanut paste, a vegetable paste, a rice gruel, or a soft ice cream containing the proteoses.

Embodiment No. A4 is a jelly-like food containing the proteoses. This food is made by seasoning the paste-like or liquid-like proteoses derived from the animal protein with salt or sugar, by adding cream cheese or yogurt, and by being set with gelatin. The proteoses may be seasoned with lemon juice. Embodiment No. A5 is also a jelly-like food containing the proteoses. This food is made by adding a soup of dried bonito shavings to the seasoned proteoses, and by hardening with agar. A soup of tangle weeds may be further added to the seasoned proteoses. These foods are available as cold confectionery, food for old people who cannot swallow food, and baby food. The jelly-like foods further contain a mousse of fish and shellfish, a savory steamed egg custard with assorted ingredients, a pudding, or a Bavarian cream containing the proteoses.

The foods shown in embodiment Nos. A6 and A7 are made by adding a chocolate to the paste-like or liquid-like proteoses derived from the animal protein, and by mixing them with wines and spirits, if necessary. These foods are available as pieces of truffle chocolate containing the proteoses by making them into bite-sized balls, and a food with nutritional supplements containing the proteoses by forming a bar coated with other foods.

Embodiment No. A8 is a jelly-like drink containing the proteoses. This drink is made by adding the paste-like or liquid-like proteoses derived from the animal protein to various drinks, such as a sports drink or electrolyte drink, and by hardening with gellant.

Embodiment No. A9 is a bread-like food containing the proteoses. This food is made by adding salt, powdered cheese, an egg yolk, milk, salad oil, and rice flour for dumplings to the paste-like or liquid-like proteoses derived from the animal protein, and by baking the mixture in an oven. The bread-like food further contains a loaf of bread, a table bread, a snack bread, pastry, or a Danish pastry containing the proteoses.

Embodiment No. A10 is a food for snacks containing the proteoses. This food is made by adding wheat flour, salt, and seasoning to the paste-like or liquid-like proteoses derived from the animal protein, and by frying the mixture. Furthermore, for example, the food for snacks containing the DHA (docosahexaenoic acid) and the EPA (eicosapentaenoic acid) is made by adding wheat flour, salt, tuna oil, and seasoning to the proteoses having a concentration of 40 wt. %, and by frying it at 180° C. for 5 minutes. There is a diet cookie and a chocolate cookie that are both similar to the food for snacks containing the proteoses.

Embodiment No. A11 is noodles containing the proteoses. The noodles are made by adding a strong flour, soft flour, and salt to the paste-like or liquid-like proteoses derived from the animal protein, and by kneading it. Furthermore, for example, the noodles, such as udon, are made by adding to the proteoses at 33 wt. % the strong flour at 33 wt. %, the soft flour at 33 wt. %, and a bit of salt, by kneading the mixture and cutting it finely, and by boiling it for 10 minutes. There are Chinese noodles and agar noodles that are similar to these noodles, such as udon containing the proteoses.

Embodiments of the foods that use the proteoses of the animal protein hydrolyzed by the plants containing the endopeptidases are explained above. Applications of the proteoses of the animal protein to food are not restricted to these foods. The proteoses of the animal protein may be applied to various kinds of foods, such as a seafood curry, a healthy curry, and a beer curry.

In Table 7, the contents of each composition are shown for illustration only, and are not restricted to these values. The contents of the proteoses of the animal protein and other additives may be varied in response to the kinds and the purposes of the foods.

### INDUSTRIAL APPLICABILITY

The present invention may be applied to the technical field of manufacturing proteoses from animal protein. The invention may be also applied to the technical field of manufacturing foods and drinks containing the proteoses of animal protein.

TABLE 1
The Evaluation of the Methods for Manufacturing the Proteoses (1)

| Embodiment | Animal Protein | Plants | | | |
|---|---|---|---|---|---|
| No. | Sample Weight | Sample Weight | pH Value | Hydrolysis Conditions | Status of Hydrolysis |
| No. 1-1 | Fish meat protein | Mitake | Chemicals A | 4° C., for 1 hour | The MHCs are completely decomposed. |
| | 10 g | mushrooms | pH 7.2 | | The bands of the myosin disappeared. |
| | | 10 g | | | |
| No. 1-2 | ↑ | ↑ | ↑ | 4° C., for 3 hours | ↑ |
| No. 1-3 | ↑ | ↑ | ↑ | 4° C., for 12 hours | ↑ |
| No. 1-4 | ↑ | ↑ | ↑ | 4° C., for 48 hours | ↑ |
| Example | Fish meat protein | None | Chemicals A | 4° C., for 48 hours | The MHCs are not decomposed. |
| No. 1 | 10 g | | pH 7.2 | | The bands of the myosin still remain. |
| No. 2-1 | Fish meat protein | Kiwi fruit | Chemicals A | 4° C., for 1 hour | The MHCs are completely decomposed. |
| | 10 g | pulps 10 g | pH 7.2 | | The bands of the myosin disappeared. |
| No. 2-2 | ↑ | ↑ | ↑ | 4° C., for 3 hours | ↑ |
| No. 2-3 | ↑ | ↑ | ↑ | 4° C., for 12 hours | ↑ |
| No. 2-4 | ↑ | ↑ | ↑ | 4° C., for 48 hours | ↑ |
| Example | Fish meat protein | None | Chemicals A | 4° C., for 48 hours | The MHCs are not decomposed. |
| No. 2 | 10 g | | pH 7.2 | | The bands of the myosin still remain. |
| No. 3-1 | Fish meat protein | Pineapple | Chemicals A | 4° C., for 1 hour | The MHCs are completely decomposed. |
| | 10 g | pulps 10 g | pH 8 | | The bands of the myosin disappeared. |
| No. 3-2 | ↑ | ↑ | ↑ | 4° C., for 3 hours | ↑ |
| No. 3-3 | ↑ | ↑ | ↑ | 4° C., for 12 hours | ↑ |
| No. 3-4 | ↑ | ↑ | ↑ | 4° C., for 48 hours | ↑ |
| Example | Fish meat protein | None | Chemicals A | 4° C., for 48 hours | The MHCs are not decomposed. |
| No. 3 | 10 g | | pH 8 | | The bands of the myosin still remain. |

TABLE 2
The Evaluation of the Methods for Manufacturing the Proteoses (2)

| Embodiment | Animal Protein | Plants | | | |
|---|---|---|---|---|---|
| No. | Sample Weight | Sample Weight | pH Value | Hydrolysis Conditions | Status of Hydrolysis |
| No. 4-1 | Fish meat protein | Papaya pulps | Chemicals A | 4° C., for 1 hour | The MHCs are completely decomposed. |
| | 10 g | 10 g | pH 7.2 | | The bands of the myosin disappeared. |
| No. 4-2 | ↑ | ↑ | ↑ | 4° C., for 3 hours | ↑ |
| No. 4-3 | ↑ | ↑ | ↑ | 4° C., for 12 hours | ↑ |
| No. 4-4 | ↑ | ↑ | ↑ | 4° C., for 48 hours | ↑ |
| Example | Fish meat protein | None | Chemicals A | 4° C., for 48 hours | The MHCs are not decomposed. |
| No. 4 | 10 g | | pH 7.2 | | The bands of the myosin still remain. |
| No. 5-1 | Fish meat protein | Papaya peels | Chemicals A | 4° C., for 1 hour | The MHCs are completely decomposed. |
| | 10 g | 10 g | pH 7.2 | | The bands of the myosin disappeared. |
| No. 5-2 | ↑ | ↑ | ↑ | 4° C., for 3 hours | ↑ |
| No. 5-3 | ↑ | ↑ | ↑ | 4° C., for 12 hours | ↑ |
| No. 5-4 | ↑ | ↑ | ↑ | 4° C., for 48 hours | ↑ |
| Example | Fish meat protein | None | Chemicals A | 4° C., for 48 hours | The MHCs are not decomposed. |
| No. 5 | 10 g | | pH 7.2 | | The bands of the myosin still remain. |

TABLE 3
The Evaluation of the Methods for Manufacturing the Proteoses (3)

| Embodiment | Animal Protein | Plants | | | |
|---|---|---|---|---|---|
| No. | Sample Weight | Sample Weight | pH Value | Hydrolysis Conditions | Status of Hydrolysis |
| No. 6 | Frozen | Papaya peels | No control | After vacuum packing | A proteose is produced which does not |
| | fish meat paste | 3 g | | 70° C., for 10 minutes | form a gel. The protein concentration of |
| | 97 g | | | | the proteose is 165 mg/ml, the same as |
| | | | | | that of the frozen fish meat paste. |
| No. 7 | ↑ | Green papaya | ↑ | After vacuum packing | ↑ |
| | | peels 3 g | | 70° C., for 10 minutes | |
| No. 8 | ↑ | Mitake | ↑ | After vacuum packing | ↑ |
| | | mushroom caps | | 60° C., for 10 minutes | |
| | | 3 g | | | |
| No. 9 | ↑ | Mitake | ↑ | After vacuum packing | ↑ |
| | | mushroom | | 60° C., for 10 minutes | |
| | | stalks 3 g | | | |
| No. 10 | Frozen fish meat | Papaya peels | ↑ | After vacuum packing | A proteose is produced which does not |
| | paste 94 g with | 3 g | | 70° C., for 10 minutes | form a gel. However, the activity of the |
| | salt 3 g | | | | endopeptidase is slightly reduced. |
| No. 11 | ↑ | Mitake | ↑ | After vacuum packing | ↑ |
| | | mushrooms 3 g | | 70° C., for 10 minutes | |

TABLE 4
The Evaluation of the Methods for Manufacturing the Proteoses (4)

| Embodiment | Animal Protein | Plants | | | |
|---|---|---|---|---|---|
| No. | Sample Weight | Sample Weight | pH Value | Hydrolysis Conditions | Status of Hydrolysis |
| No. 12 | Frozen | Papaya peels | No | After vacuum packing | A proteose is produced which does not |
| | fish meat paste | 3 g | Control | 70° C., for 10 minutes | form a gel. |
| | 97 g | | | | |
| | Preheated up to | | | | |
| | 85° C., for 30 min. | | | | |
| No. 13 | ↑ | Mitake mushroom | ↑ | After vacuum packing | ↑ |
| | | caps 3 g | | 60° C., for 10 minutes | |
| No. 14 | ↑ | Mitake mushroom | ↑ | After vacuum packing | ↑ |
| | | stalks 3 g | | 60° C., for 10 minutes | |
| No. 15 | Ground leg meat | Papaya peels | ↑ | After vacuum packing | A proteose is produced which does not |
| | of chicken 97 g | 3 g | | 70° C., for 10 minutes | form a gel. The protein concentration of |
| | | | | | the protrose is 200 mg/ml, the same as |
| | | | | | that of the ground leg meat of chickens. |
| No. 16 | ↑ | Mitake mushroom | ↑ | After vacuum packing | ↑ |
| | | caps 3 g | | 60° C., for 10 minutes | |
| No. 17 | ↑ | Mitake mushroom | ↑ | After vacuum packing | ↑ |
| | | stalks 3 g | | 60° C., for 10 minutes | |
| No. 18 | Ground pork | Papaya peels | ↑ | After vacuum packing | A proteose is produced which does not |
| | 97 g | 3 g | | 70° C., for 10 minutes | form a gel. The protein concentration of |
| | | | | | the protrose is 180 mg/ml, the same as |
| | | | | | that of ground pork. |
| No. 19 | ↑ | Mitake mushroom | ↑ | After vacuum packing | ↑ |
| | | caps 3 g | | 60° C., for 10 minutes | |
| No. 20 | ↑ | Mitake mushroom | ↑ | After vacuum packing | ↑ |
| | | stalks 3 g | | 60° C., for 10 minutes | |

TABLE 5
The Evaluation of the Methods for Manufacturing the Proteoses (5)

| Embodiment | Animal Protein | Plants | | | |
|---|---|---|---|---|---|
| No. | Sample Weight | Sample Weight | pH Value | Hydrolysis Conditions | Status of Hydrolysis |
| No. 21 | Fish meat | Papaya peels | Controlled with | 70° C., for 10 minutes | The MHCs are completely decomposed. |
| | protein 0.5 g | 0.25 g | Chemicals A | | |
| | | | and B | | |
| | | | pH 2, 3, 4, 5, 6, 7, | | |
| | | | 8, 9, 10, and 11 | | |
| No. 22 | ↑ | Mitake | Controlled with | 60° C., for 10 minutes | The MHCs are completely decomposed. |
| | | mushrooms | Chemicals A | | The activity of the endopeptidases at the |
| | | 0.25 g | and B | | pH value range between 4 and 9 is |
| | | | pH 2, 3, 4, 5, 6, 7, | | higher. |
| | | | 8, 9, 10, and 11 | | |
| No. 23 | Frozen | Papaya peels | No control | After vacuum packing | The protein of the frozen fish meat paste |
| | fish meat paste | 3 g | | 0, 10, 20, 30, 40, 50, 60, | is sufficiently hydrolyzed. |
| | 97 g | | | 70, and 80° C., for 10 | The activity of the endopeptidase at |
| | | | | minutes | 70° C. is the highest. |
| No. 24 | ↑ | Mitake | ↑ | After vacuum packing | The protein of the frozen fish meat paste |
| | | mushroom | | 0, 10, 20, 30, 40, 50, 60, | is sufficiently hydrolyzed. |
| | | stalks 3 g | | 70, and 80° C., for 10 | The activity of the endopeptidase at |
| | | | | minutes | 60° C. is the highest. |

TABLE 6
The Evaluation of the Methods for Manufacturing the Proteoses (6)

| Embodiment | Animal Protein | Plants | | | |
|---|---|---|---|---|---|
| No. | Sample Weight | Sample Weight | pH Value | Hydrolysis Conditions | Status of Hydrolysis |
| No. 25 | Frozen | Mitake | No control | After vacuum packing | The protein of the frozen fish meat paste |
| | fish | mushroom | | 0, 10, 20, 30, 40, 50, 60, | is sufficiently hydrolyzed. |
| | meat paste | stalks 3 g | | 70, and 80° C., for 10 | The activity of the endopeptidase at |
| | 97 g | | | minutes | 60° C. is the highest. |
| No. 26 | Frozen | Papaya peels | ↑ | After vacuum packing | The protein of the frozen fish meat paste |
| | fish | 2, 5, 10, 20, 30, | | 70° C., for 10 minutes | is sufficiently hydrolyzed. |
| | meat paste | 40, and 50 g | | | |
| | 100 g | | | | |
| No. 27 | Frozen | Mitake | ↑ | After vacuum packing | The protein of the frozen fish meat paste |
| | fish | mushroom | | 60° C., for 10 minutes | is sufficiently hydrolyzed. |
| | meat paste | stalks | | | |
| | 100 g | 2, 5, 10, 20, 30, | | | |
| | | 40, and 50 g | | | |

TABLE 7
Foods Containing the Proteoses

| Embodiment | | | | |
|---|---|---|---|---|
| No. | Classification | Title | Constituents | Uses |
| No. A1 | Seasoned | Sesame paste | 85 wt. % proteoses of fish meat protein, 7 wt. % | Spread-type foods bread |
| | proteoses | | sesame paste, and 8 wt. % sugar | and crackers |
| No. A2 | ↑ | Chocolate | 60 wt. % proteoses of fish meat protein, 32 wt. % | ↑ |
| | | paste | chocolate, and 8 wt. % sugar | |
| No. A3 | ↑ | Soybean flour | 50 wt. % proteoses of fish meat protein, 25 wt. % | ↑ |
| | | paste | soybean flour, and 25 wt. % sugar | |
| No. A4 | Foods having | Yogurt jelly | 14 wt. % proteoses of fish meat protein, 9 wt. % cream | Cold confectionery |
| | proteoses | | cheese, 70 wt. % yogurt, 5 wt. % sugar, 2 wt. % gelatin | |
| No. A5 | ↑ | Protein jelly | 50 wt. % proteoses of fish meat protein, 1.5 wt. % salt, | Foods for the elderly |
| | | | 48.5 wt. % soup of dried bonito shavings, a bit of agar | |
| No. A6 | ↑ | Truffle | 40 wt. % proteoses of fish meat protein, 60 wt. % | Chocolate-like confectionery |
| | | chocolate | chocolate, small amount of wines and spirits | |
| No. A7 | ↑ | Chocolate bar | 30 wt. % proteoses of fish meat protein, 70 wt. % | Chocolate-like confectionery |
| | | | chocolate | Foods with nutritional |
| | | | | supplements |
| No. A8 | ↑ | Jelly-like drink | 5 wt. % proteoses of fish meat protein, 94 wt. % | Lactic acid drinks, fruit drinks |
| | | | electrolyte drink, a bit of gellant | jelly-like drinks |
| No. A9 | ↑ | Brazil bread | 25 wt. % proteoses of fish meat protein, 75 wt. % salt, | Bread |
| | | | powdered cheese, egg yolk, milk, salad oil, and rice | |
| | | | flour for dumplings. The mixture is baked in an | |
| | | | oven | |
| No. A10 | ↑ | Fish snack | 40 wt. % proteoses of fish meat protein, 60 wt. % salt, | Snacks |
| | | | wheat flour, tuna oil, and seasoning. The mixture is | |
| | | | fried in oil. | |
| No. A11 | ↑ | Noodles | 33 wt. % of fish meat protein, 67 wt. % salt, | Noodles |
| | | | strong flour, and soft flour. The mixture is kneaded | |
| | | | and boiled. | |

1. A method for manufacturing proteoses derived from animal protein, comprising:
a cutting step to finely cut animal protein and plants containing endopeptidases,
a mixing step to mix the animal protein with the plants,
a hydrolyzing step to hydrolyze the animal protein by the endopeptidases, and
an ending step to stop the activity of the endopeptidases.

2. A method for manufacturing proteoses derived from animal protein according to claim 1 wherein said plants containing endopeptidases include one or more of a papaya, a maitake mushroom, a fig, a kiwi fruit, a pineapple, a melon, and fresh ginger.

3. A method for manufacturing proteoses derived from animal protein according to any of claims 1 and 2 wherein said mixing step is to mix the animal protein with the plants so that a mixture is maintained at a range of a pH between 2.0 and 11.0, and for at least one minute at a temperature between 0 and 75° C.

4. A method for manufacturing proteoses derived from animal protein according to any of claims 1 to 3 wherein said mixing step is to mix the animal protein with the plants so that the wt. % of the animal protein is 0.1 to 99.9, and the wt. % of the plants containing the endopeptidases is 0.1 to 99.9.

5. A method for manufacturing proteoses derived from animal protein according to any of claims 1 to 3 wherein said mixing step is to mix the animal protein with the plants so that the wt. % of the animal protein is 80 to 99.5, and the wt. % of the plants containing the endopeptidase is 0.5 to 20.

6. Proteoses derived from animal protein made by said methods according to any of claims 1 to 5.

7. Food and drink containing said proteoses derived from animal protein made by the methods according to any of claims 1 to 5.
